(19) United States
(12) Patent Application Publication
(10) Pub. No.: US 2015/0215848 A1
(43) Pub. Date: Jul. 30, 2015

(54) DISCOVERY METHOD AND APPARATUS IN TERMINAL-TO-TERMINAL DIRECT COMMUNICATION

(71) Applicant: ELECTRONICS AND TELECOMMUNICATIONS RESEARCH INSTITUTE, Daejeon (KR)

(72) Inventors: Mi Jeong YANG, Daejeon (KR); Soon Yong LIM, Daejeon (KR); Jae Wook SHIN, Daejeon (KR); Pyeong Jung SONG, Daejeon (KR)

(73) Assignee: ELECTRONICS AND TELECOMMUNICATIONS RESEARCH INSTITUTE, Daejeon (KR)

(21) Appl. No.: 14/597,332

(22) Filed: Jan. 15, 2015

(30) Foreign Application Priority Data
Jan. 24, 2014 (KR) 10-2014-0008728

(51) Int. Cl. H04W 48/14

(52) U.S. Cl. CPC H04W 48/14; H04W 48/10

(57) ABSTRACT

A discovery method is provided by a terminal in a terminal-to-terminal direct communication terminal-to-terminal direct communication. The terminal broadcasts a sequence, and receives an echo sequence on the sequence from other terminal. The terminal scrambles discovery information with the sequence, and transmits the scrambled discovery information.

### CROSS-REFERENCE TO RELATED APPLICATION

This application claims priority to and the benefit of Korean Patent Application No. 10-2014-0008728 filed in the Korean Intellectual Property Office on Jan. 24, 2014, the entire contents of which are incorporated herein by reference.

### BACKGROUND

(a) Field

The described technology generally relates to a discovery method and apparatus in terminal-to-terminal direct communication.

(b) Description of the Related Art

Recently, techniques for providing terminal-to-terminal direct communication for terminals located at the same cell or neighboring cells are researched in wireless communication systems. The terminal-to-terminal direct communication is called a device-to-device (D2D) communication.

In the terminal-to-terminal direct communication, data are directly transmitted or received between neighboring terminals without passing a base station. For the terminal-to-terminal direct communication, a discovery procedure in which neighboring terminals discovers mutual presence is required.

In the conventional discovery procedure, each terminal exchanges signal with a specific entity such as a base station to discover other terminal. However, in order to provide the proximity service, it is required for the neighboring terminals to distributedly perform the discovery procedure to discover the mutual presence without the help of the specific entity.

The above information disclosed in this Background section is only for enhancement of understanding of the background of the invention and therefore it may contain information that does not form the prior art that is already known in this country to a person of ordinary skill in the art.

### SUMMARY OF THE INVENTION

An embodiment of the present invention provides a discovery method and apparatus in terminal-to-terminal direct communication for discovering presence.

According to another embodiment of the present invention, a discovery method is provided by a first terminal in a terminal-to-terminal direct communication. The first terminal broadcasts a sequence, receives an echo sequence on the sequence from a second terminal, scrambles discovery information of the first terminal with the sequence, and transmits the scrambled discovery information.

When transmitting the scrambled discovery information, the first terminal may transmit the scrambled discovery information over a discovery information broadcast resource that is mapped to a sequence broadcast resource over which the echo sequence is transmitted.

The first terminal may further receive an echo sequence on the sequence from a third terminal. In this case, when transmitting the scrambled discovery information, the first terminal may transmit the scrambled discovery information over a discovery information broadcast resource that is mapped to a sequence broadcast resource over which the echo sequence of the second terminal is transmitted, and may transmit the scrambled discovery information over a discovery information broadcast resource that is mapped to a sequence broadcast resource over which the echo sequence of the third terminal is transmitted.

The first terminal may further receive an echo sequence on the sequence from a third terminal. In this case, when a sequence broadcast resource over which the echo sequence of the second terminal is transmitted is same as a sequence broadcast resource over which the echo sequence of the third terminal is transmitted, the first terminal may transmit the scrambled discovery information over a discovery information broadcast resource that is mapped to the same sequence broadcast resource.

The discovery information may include at least one of identification information of the first terminal, user information of the first terminal, service identification information of the first terminal, or information according to an operation of the first terminal after discovery.

The first terminal may further receive discovery setup information comprising a sequence set from a discovery coordination entity, and may select the sequence to be broadcasted from among the sequence set.

When selecting the sequence, the first terminal may select any one sequence from among the sequence set, transmit the selected sequence to the discovery coordination entity, and determine the selected sequence as the sequence to be broadcasted when receiving an echo sequence on the selected sequence from the discovery coordination entity.

The first terminal may further reselect any one sequence from among the sequence set when failing to receive the echo sequence on the selected sequence from the discovery coordination entity.

The discovery setup information may further include information about a sequence broadcast resource for transmitting the sequence and information about a discovery broadcast resource for transmitting the discovery information.

According to yet another embodiment of the present invention, a discovery method is provided by a first terminal in a terminal-to-terminal direct communication. The first terminal receives a sequence from a second terminal, transmits an echo sequence on the sequence when storing no information about the sequence, receives discovery information from the second terminal, and acquires the discovery information by descrambling the discovery information with the sequence.

When receiving the discovery information, the first terminal may receive the discovery information at a discovery information broadcast resource that is mapped to a sequence broadcast resource over which the echo sequence is transmitted.

The first terminal may further perform backoff when failing to receive the discovery information after transmitting the echo sequence, and retransmit the echo sequence after the backoff.

A backoff value of the first terminal may be different from a backoff value of other terminal.

According to yet another embodiment of the present invention, a discovery support method is provided by a discovery coordination entity (DCE) in a terminal-to-terminal direct communication. The DCE broadcasts discovery setup information including a sequence set, receives from a terminal a sequence selected from among the sequence set, determines whether the selected sequence is used, and transmits an echo sequence on the selected sequence when the selected sequence is not used.

The DCE may notify that it is possible for the terminal to use the selected sequence at a discovery procedure by transmitting the echo sequence.

The discovery setup information may further include information about resources used at the discovery procedure.

The DCE may further receive from the terminal other sequence selected from among the sequence set when the selected sequence is being used.

According to yet another embodiment of the present invention, a discovery apparatus is provided in a terminal-to-terminal direct communication. The apparatus includes a processor and a transceiver. The processor selects a sequence, and scrambles discovery information with the sequence when receiving an echo sequence on the sequence. The transceiver broadcasts the sequence, receives the echo sequence from a first terminal, and transmits the scrambled discovery information.

The processor may further select a discovery information broadcast resource that is mapped to a sequence broadcast resource over which the echo sequence is transmitted, as a resource for transmitting the scrambled discovery information over.

When the transceiver receives a second sequence from a second terminal, the processor may further transmit an echo sequence on the second sequence through the transceiver if storing no information about the second sequence. When the transceiver fails to receive discovery information from the second terminal, the processor may further perform backoff and retransmit the echo sequence on the second sequence through the transceiver.

### BRIEF DESCRIPTION OF THE DRAWINGS

FIG. 1 schematically shows a terminal-to-terminal direct communication according to an embodiment of the present invention.

FIG. 2 shows an example of a discovery method in a terminal-to-terminal direct communication according to an embodiment of the present invention.

FIG. 3 shows a resource usage example of a discovery method in a terminal-to-terminal direct communication according to an embodiment of the present invention.

FIG. 4 shows a sequence acquisition procedure of a discovery method in a terminal-to-terminal direct communication according to an embodiment of the present invention.

FIG. 5 and FIG. 6 each show an example of a discovery method in a terminal-to-terminal direct communication according to an embodiment of the present invention.

FIG. 7A and FIG. 7B show an example of a discovery method in a terminal-to-terminal direct communication according to another embodiment of the present invention.

FIG. 8 is a schematic block diagram of a discovery apparatus according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “terminal” may designate a user equipment (UE), a mobile terminal (MT), a mobile station (MS), an advanced mobile station (AMS), a high reliability mobile station (HR-MS), a subscriber station (SS), a portable subscriber station (PSS), an access terminal (AT), and so on, or may include all or some functions thereof.

Further, the term “base station” (BS) may designate a node B, an evolved node B (eNB), an advanced base station (ABS), a high reliability base station (HR-BS), an access point (AP), a radio access station (RAS), a base transceiver station (BTS), and so on, or may include all or some functions thereof.

A discovery method and apparatus in terminal-to-terminal direct communication according to an embodiment of the present invention is described with reference to the drawings.

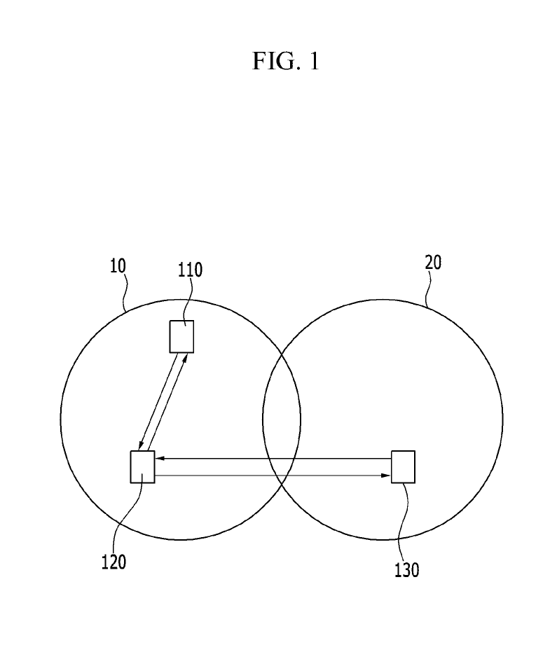

FIG. 1 schematically shows a terminal-to-terminal direct communication according to an embodiment of the present invention.

Referring to FIG. 1, a terminal 110 discovers other terminals 120 and 130 by a discovery procedure, and performs synchronization with the other terminals 120 and 130. Then, the terminal 110 exchanges data with the terminals 120 and 130. The terminal 110 may perform the direct communication with the terminal within a cell 10, and may perform the direct communication with the terminal 130 of other cell 20.

When a base station (not shown) exists, the base station may perform network control for the terminals 110, 120, and 130.

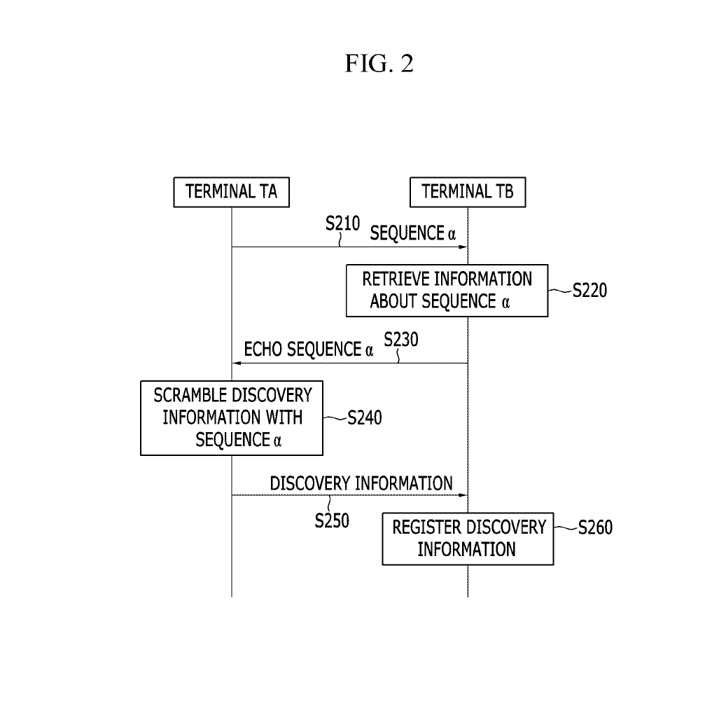

FIG. 2 shows an example of a discovery method in a terminal-to-terminal direct communication according to an embodiment of the present invention.

Referring to FIG. 2, a terminal TA puts its own sequence (sequence α) on one resource of sequence broadcast resources and broadcasts sequence α (S210). The sequence broadcast resources may be time-frequency resources. The terminal TA may periodically broadcast the sequence α.

A terminal TB recognizes that sequence α is broadcasted by receiving the sequence broadcast resources, and searches for information about sequence α from its own discovery database (S220). When the database does not include the information about sequence α, the terminal TB puts sequence α on any sequence broadcast resource and transmits sequence α (S230). The sequence that is transmitted by terminal TB again is called an echo sequence. In this case, the terminal TB may broadcast the echo sequence.

When the terminal TA recognizes its own sequence (sequence α) at the sequence broadcast resources, the terminal TA can know that a terminal having no discovery information about the terminal TA exists. Accordingly, the terminal TA scrambles the discovery information with sequence α (S240), and puts the scrambled discovery information on a discovery information broadcast resource and transmits the scrambled discovery information (S250). In this case, the terminal TA may broadcast the scrambled discovery information. The discovery information may include terminal identification information such as terminal information for identifying a terminal or user information of the terminal. The terminal information may be, for example, an IMSI (international mobile subscriber identity) or an MSISDN (mobile subscriber integrated services digital network-number). The discovery information may include service identification information of the terminal. The discovery information may include use case after the discovery procedure or information required according to an application to be executed.

Next, the terminal TB descrambles data received at the discovery information broadcast resource with sequence α to acquire the discovery information transmitted by the terminal TA (S260). According to some embodiments, the discovery information broadcast resource may be a resource mapped to the sequence broadcast resource carrying the echo sequence. Therefore, the terminal TB can acquire the discovery information of the terminal TA by descrambling with sequence α the data received at the discovery information broadcast resource that is mapped to the resource over which the terminal TB has transmitted the echo sequence. After acquiring the discovery information, the terminal TB associates the discovery information of the terminal TA with the sequence α, and registers the discovery information and sequence α to the discovery database. If the terminal TB does not receive a certain sequence during a predetermined period, the terminal can remove the certain sequence from the discovery database.

As described above, according to an embodiment of the present invention, the specific entity cannot allocate and manage discovery information, and a terminal can store its own discovery information and inform neighbor terminal of the discovery information. That is, a distributed discovery method can be provided. Further, since the sequence broadcast resources and the discovery information broadcast resources are the known time-frequency resources, the same time-frequency resources are used between cells as well as within a cell and such that the discovery procedure can be performed between terminals belonging to different cells.

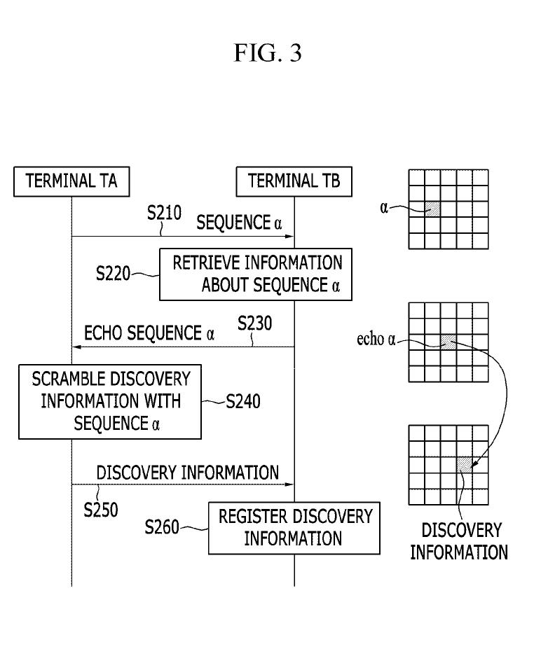

FIG. 3 shows a resource usage example of a discovery method in a terminal-to-terminal direct communication according to an embodiment of the present invention.

Referring to FIG. 3, each terminal selects a resource for transmitting a sequence from among sequence broadcast resources. In FIG. 3, it is assumed that the sequence broadcast resources include sequence broadcast resources #0, #1, #2, #3, and #4. In this case, a terminal TA selects any sequence broadcast resource (sequence broadcast resource #2 in FIG. 3), and puts sequence α on the selected sequence broadcast resource #2 and transmits the sequence α. A terminal TB selects any sequence broadcast resource (sequence broadcast resource #1 in FIG. 3), and puts an echo sequence on the selected sequence broadcast resource #1 and transmits the echo sequence.

In an embodiment of the present invention, discovery information broadcast resources are mapped to the sequence broadcast resources. As shown in FIG. 3, assuming that the sequence broadcast resources include sequence broadcast resource #0, #1, #2, #3, and #4, the discovery information broadcast resources include discovery information broadcast resource #0, #1, #2, #3, and #4 that are mapped to sequence broadcast resource #0, #1, #2, #3, and #4, respectively. Accordingly, when the terminal TB transmits the echo sequence on sequence broadcast resource #1, the terminal TA transmits discovery information on discovery information broadcast resource #1 that is mapped to sequence broadcast resource #1. Then, the terminal TB can wait in the discovery information broadcast resource mapped to the sequence broadcast resource over which it has transmitted the echo sequence, thereby receiving the discovery information.

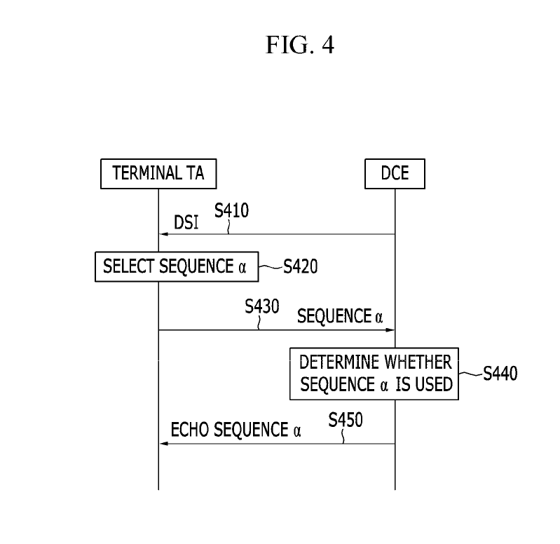

FIG. 4 shows a sequence acquisition procedure of a discovery method in a terminal-to-terminal direct communication according to an embodiment of the present invention.

Referring to FIG. 4, a discovery coordination entity (DCE) periodically broadcasts discovery setup information (DSI) for a discovery (S410). The DCE exists within a discovery area where the discovery is performed, terminal. The DCE may be a base station or other entity. The DSI includes discovery resource information within the discovery area and a sequence set to be used by terminals.

A terminal TA entering the discovery area receives the DSI broadcasted by the DCE, and selects any sequence from among the sequence set included in the DSI (S420). Next, the terminal TA transmits the selected sequence a to the DCE (S430), and the DCE determines whether sequence α received from the terminal TA is used by other terminals (S440). When sequence α is not used by the other terminals and can be used by the terminal TA, the DCE transmits sequence α by the terminal TA to the terminal TA as an echo sequence (S450). Accordingly, the terminal TA can use sequence α at the discovery procedure.

On the other hand, when the other terminal uses the sequence α, the DCE does not transmit the echo sequence to the terminal TA. If the terminal TA does not receive the echo sequence from the DCE during a predetermined time, the terminal TA can repeat a procedure selecting other sequence from among the sequence set and transmitting the selected sequence to the DCE again, thereby acquiring a usable sequence.

The discovery resource information includes information about a sequence broadcast resource and information about a discovery information broadcast resource. The discovery resource information may further include information resource for sequence selection. The resource for sequence selection may include a sequence request resource and a sequence response resource. Then, the terminal TA transmits the selected sequence to the DCE over the sequence request resource, and the DCE transmits the echo sequence for responding the selected sequence over the sequence response resource.

As described above, according to an embodiment of the present invention, the DCE provides a terminal with discovery resource information and a sequence set such that a discovery procedure for a terminal-to-terminal direct communication can be performed between terminals located at different cells as well as terminals located at the same cell.

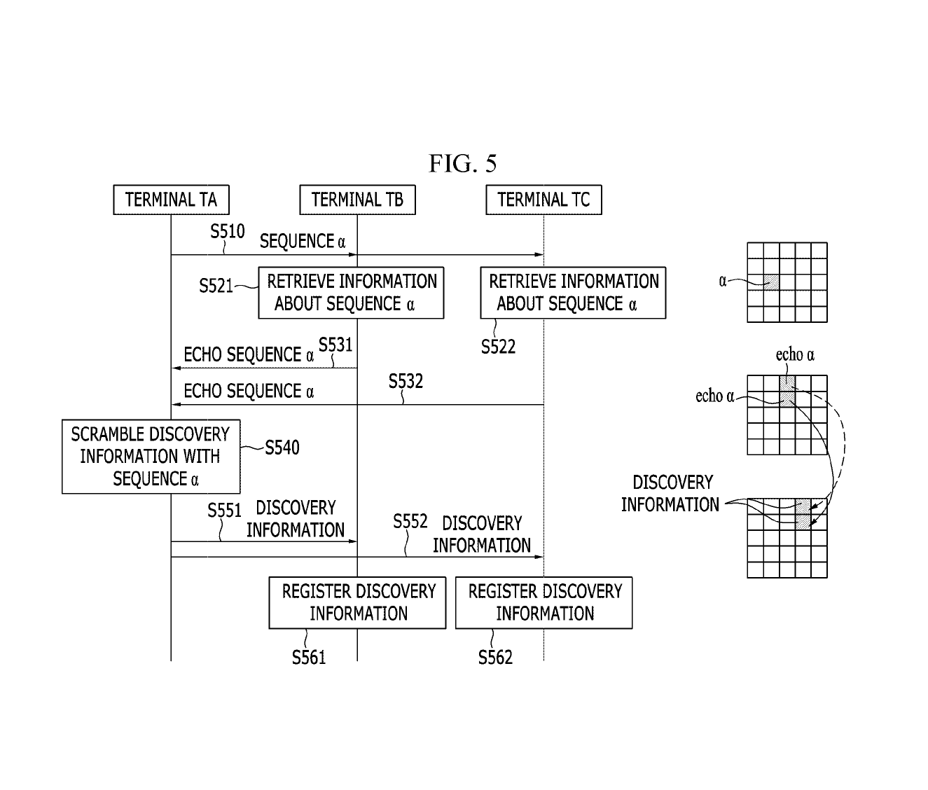

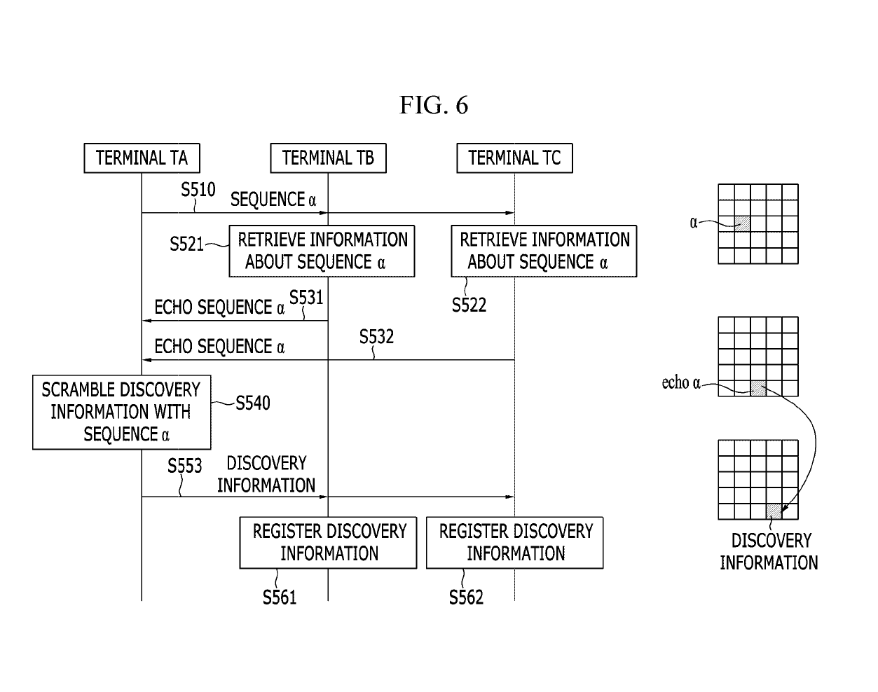

FIG. 5 and FIG. 6 each show an example of a discovery method in a terminal-to-terminal direct communication according to an embodiment of the present invention.

Referring to FIG. 5 and FIG. 6, a plurality of terminals TB and TC receive sequence α that is broadcasted over a sequence broadcast resource by a terminal TA (S510).

When information about sequence α does not exist in databases of the terminals TB and TC (S521 and S522), each of the terminals TB and TC transmits an echo sequence by putting sequence α on a sequence broadcast resource (S531 and S532).

If the terminal TA recognizes its own sequence (sequence α) on the sequence broadcast resource, the terminal TA scrambles discovery information with sequence α (S540), and transmits the scrambled discovery information over a discovery information broadcast resource (S551 and S552). As shown in FIG. 5, in the case that the terminals TB and TC transmit the echo sequence over the different sequence broadcast resources, the terminal TA transmits the discovery information over discovery information broadcast resources that are respectively mapped to the sequence broadcast resources over which the terminals TB and TC have transmitted. Then, each of the terminals TB and TC acquires the discovery information of the terminal TA by descrambling with sequence α data received at the discovery information broadcast resource that is mapped to the resource over which it has transmitted the echo sequence (S561 and S562).

As shown in FIG. 6, the terminals TB and TC may transmit the echo sequence over the same sequence broadcast resource (S533 and S534). In this case, since the same discovery information broadcast resource is mapped to the sequence broadcast resource over which the terminals TB and TC have transmitted the echo sequences, the terminal TA puts the discovery information on one discovery information resource and transmits the discovery information to the plurality of terminals TB and TC (S563). As such, in the case that the different terminals transmits the echo sequences over the same sequence broadcast resource, the terminal initiating the discovery procedure can provide a plurality of terminals with discovery information by using a single response.

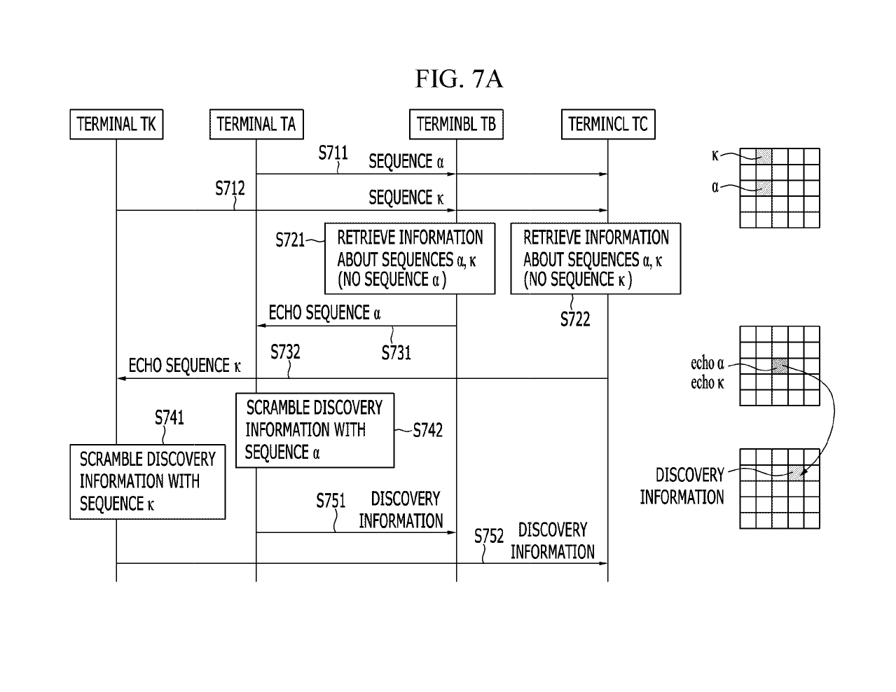

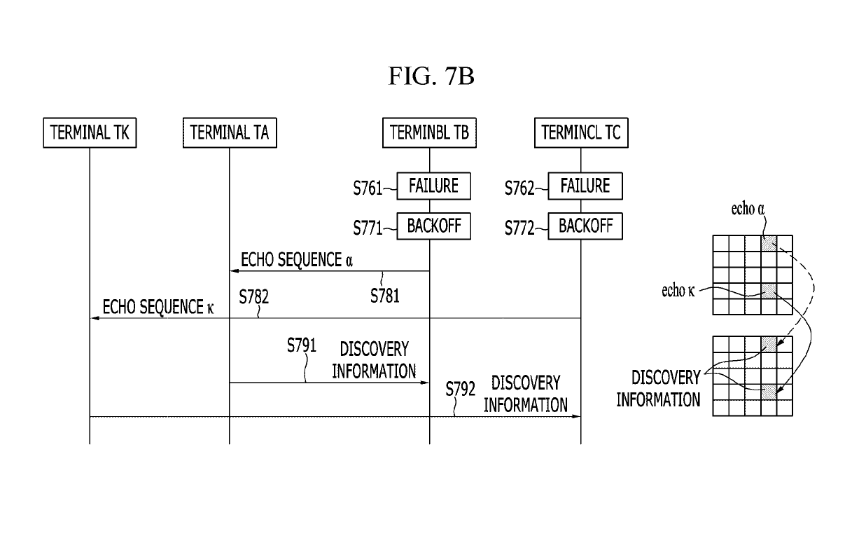

FIG. 7A and FIG. 7B show an example of a discovery method in a terminal-to-terminal direct communication according to another embodiment of the present invention.

Referring to FIG. 7A, a terminal TA broadcasts sequence α (S711), and a terminal TK broadcasts sequence κ (S712). A terminal TB having no information about sequence α transmits sequence α as an echo sequence (S721 and S731), and a terminal TC having no information about sequence κ transmits sequence κ as an echo sequence (S722 and S732). As shown in FIG. 7, the two echo sequence may occupy the same sequence broadcast resource.

On receiving the echo sequence α, the terminal TA scrambles its own discovery information with sequence α (S741), and transmits the scrambled discovery information over a discovery information broadcast resource (S751). Similarly, on receiving the echo sequence κ, the terminal TK scrambles its own discovery information with sequence κ (S742), and transmits the scrambled discovery information over a discovery information broadcast resource (S752). In the case that the terminals TB and TC transmit the echo sequences using the same sequence broadcast resource, the terminals TA and TK use the same discovery information broadcast resource. Accordingly, data of the terminal TA and data of the terminal TK that use the same discovery information broadcast resource collides with each other such that the terminals TB and TC cannot successfully receive the discovery information.

Referring to FIG. 7B, when failing to receive the discovery information (S761 and S762), the terminals TB and TC performs backoff (S771 and S772), and retransmit the echo sequences (S781 and S782). In other words, the terminals TB and TC move the sequence broadcast resources by backoff values and then retransmit the echo sequences. The different terminals may have the different backoff values. Since the sequence broadcast resources over which the terminals TB and TC retransmit the echo sequences are different by the backoff, the terminals TA and TK transmit the discovery information over the different discovery information broadcast resources (S791 and S792). Accordingly, data which the terminals TB and TC receive over the discovery information broadcast resources do not collide with each other such that the terminals TB and TC can successfully receive the discovery information.

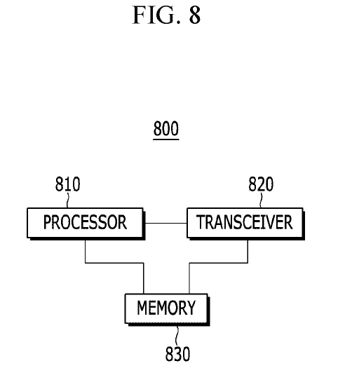

FIG. 8 is a schematic block diagram of a discovery apparatus according to an embodiment of the present invention.

Referring to FIG. 8, a discovery apparatus 800 includes a processor 810, a transceiver 820, and a memory 830. The discovery apparatus 800 may be included in a terminal, or may be the terminal itself.

The processor 810 selects sequence α from among a sequence set provided by a DCE, and selects a sequence broadcast resource for transmitting sequence α. Upon recognizing an echo sequence α transmitted from other terminal, the processor 810 scrambles discovery information with sequence α, and selects a discovery information broadcast resource that is mapped to the sequence broadcast resource carrying the echo sequence.

Upon receiving sequence β selected by other terminal, the processor 810 retrieves information about sequence β. When a discovery database does not include the information about sequence β, the processor 810 transmits an echo sequence β over sequence broadcast resource through the transceiver 820. Further, upon recognizing the discovery information at the discovery information broadcast resource mapped to the sequence broadcast resource over which the echo sequence has been transmitted, the processor 810 descrambles the discovery information with sequence β to acquire the discovery information. When failing to receive the discovery information, the processor 810 performs backoff and then retransmits an echo sequence.

The transceiver 820 broadcasts the selected sequence α, and receives the echo sequence α from other terminal. Upon receiving sequence β from other terminal, the transceiver 820 transmits the echo sequence β.

The memory 830 stores instructions to be executed by the processor 810, or loads the instructions from a storage device (not shown) and temporarily store them. The processor 810 executes the instructions stored or loaded in the memory 830. The memory 830 or the storage device may store the discovery database.

The processor 810 and the memory 830 may be connected through a bus (not shown), and an input/output interface (not shown) may be connected to the bus. The input/output interface may be connected with the transceiver 820 and peripheral devices such as an input device, a display device, a speaker, and/or the storage device.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A discovery method by a first terminal in a terminal-to-terminal direct communication, the method comprising:
broadcasting a sequence;
receiving an echo sequence on the sequence from a second terminal;
scrambling discovery information of the first terminal with the sequence; and
transmitting the scrambled discovery information.

2. The method of claim 1, wherein transmitting the scrambled discovery information comprises transmitting the scrambled discovery information over a discovery information broadcast resource that is mapped to a sequence broadcast resource over which the echo sequence is transmitted.

3. The method of claim 1, further comprising receiving an echo sequence on the sequence from a third terminal,
wherein transmitting the scrambled discovery information comprises:
transmitting the scrambled discovery information over a discovery information broadcast resource that is mapped to a sequence broadcast resource over which the echo sequence of the second terminal is transmitted; and
transmitting the scrambled discovery information over a discovery information broadcast resource that is mapped to a sequence broadcast resource over which the echo sequence of the third terminal is transmitted.

4. The method of claim 1, further comprising receiving an echo sequence on the sequence from a third terminal,
wherein transmitting the scrambled discovery information comprises, when a sequence broadcast resource over which the echo sequence of the second terminal is transmitted is same as a sequence broadcast resource over which the echo sequence of the third terminal is transmitted, transmitting the scrambled discovery information over a discovery information broadcast resource that is mapped to the same sequence broadcast resource.

5. The method of claim 1, wherein the discovery information comprises at least one of identification information of the first terminal, user information of the first terminal, service identification information of the first terminal, or information according to an operation of the first terminal after discovery.

6. The method of claim 1, further comprising:
receiving discovery setup information comprising a sequence set from a discovery coordination entity; and
selecting the sequence to be broadcasted from among the sequence set.

7. The method of claim 6, wherein selecting the sequence comprises:
selecting any one sequence from among the sequence set;
transmitting the selected sequence to the discovery coordination entity; and
determining the selected sequence as the sequence to be broadcasted when receiving an echo sequence on the selected sequence from the discovery coordination entity.

8. The method of claim 7, further comprising reselecting any one sequence from among the sequence set when failing to receive the echo sequence on the selected sequence from the discovery coordination entity.

9. The method of claim 6, wherein the discovery setup information further comprises information about a sequence broadcast resource for transmitting the sequence and information about a discovery broadcast resource for transmitting the discovery information.

10. A discovery method by a first terminal in a terminal-to-terminal direct communication, the method comprising:
receiving a sequence from a second terminal;
transmitting an echo sequence on the sequence when storing no information about the sequence;
receiving discovery information from the second terminal; and
acquiring the discovery information by descrambling the discovery information with the sequence.

11. The method of claim 10, wherein receiving the discovery information comprises receiving the discovery information at a discovery information broadcast resource that is mapped to a sequence broadcast resource over which the echo sequence is transmitted.

12. The method of claim 10, further comprising:
performing backoff when failing to receive the discovery information after transmitting the echo sequence; and
retransmitting the echo sequence after the backoff.

13. The method of claim 11, wherein a backoff value of the first terminal is different from a backoff value of other terminal.

14. A discovery support method by a discovery coordination entity in a terminal-to-terminal direct communication, the method comprising:
broadcasting discovery setup information comprising a sequence set;
receiving from a terminal a sequence selected from among the sequence set;
determining whether the selected sequence is used; and
transmitting an echo sequence on the selected sequence when the selected sequence is not used.

15. The method of claim 14, wherein transmitting the echo sequence comprising notifying that it is possible for the terminal to use the selected sequence at a discovery procedure by transmitting the echo sequence.

16. The method of claim 15, wherein the discovery setup information further comprises information about resources used at the discovery procedure.

17. The method of claim 14, further comprising receiving from the terminal other sequence selected from among the sequence set when the selected sequence is being used.

18. A discovery apparatus in a terminal-to-terminal direct communication, the apparatus comprising:
a processor configured to select a sequence, and to scramble discovery information with the sequence when receiving an echo sequence on the sequence; and
a transceiver configured to broadcast the sequence, to receive the echo sequence from a first terminal, and to transmit the scrambled discovery information.

19. The apparatus of claim 18, wherein the processor is further configured to select a discovery information broadcast resource that is mapped to a sequence broadcast resource over which the echo sequence is transmitted, as a resource for transmitting the scrambled discovery information over.

20. The apparatus of claim 18, wherein the processor is further configured, when the transceiver receives a second sequence from a second terminal, to transmit an echo sequence on the second sequence through the transceiver if storing no information about the second sequence, and
the processor is further configured, when the transceiver fails to receive discovery information from the second terminal, to perform backoff and retransmit the echo sequence on the second sequence through the transceiver.
